(19) United States
(12) Patent Application Publication
(10) Pub. No.: US 2016/0201860 A1
(43) Pub. Date: Jul. 14, 2016

(54) Self-powered wearable luminous device

(71) Applicant: Bing Tang, Guangzhou (CN)

(72) Inventors: Bing Tang, Guangzhou (CN); Weiqiang Rui, Guangzhou (CN)

(73) Assignee: Bing Tang

(21) Appl. No.: 15/075,848

(22) Filed: Mar. 21, 2016

(30) Foreign Application Priority Data
Sep. 28, 2015 (CN) 201520757497.1

(51) Int. Cl. F21L 14/00

(52) U.S. Cl. CPC F21L 14/00; F21Y 2101/02; F21W 2111/10

(57) ABSTRACT

A self-powered wearable luminous device belongs to a technical field of the self-powered wearable device which is capable of achieving self-powering by collecting kinetic energy of the human body. A power generation module, an electronic component and a luminous component are connected with each other via wires and are installed within a wearable unit. The luminous component emits lights by collecting the energy generated by human motions. The present invention has simple structure and low manufacturing cost, is able to generate relatively stable and high brightness light, and achieves the self-power, so that the replacement of batteries is avoided.

### CROSS REFERENCE OF RELATED APPLICATION

The present invention claims priority under 35 U.S.C. 119(a-d) to CN 201520757497.1, filed Sep. 28, 2015.

### BACKGROUND OF THE PRESENT INVENTION

1. Field of Invention

The present invention relates to a self-powered wearable luminous device, and belongs to the technical field of the self-powered wearable luminous device which is capable of achieving self-powering by collecting kinetic energy of the human body.

2. Description of Related Arts

Currently, the wearable luminous device has a common problem that the battery needs frequently being charged or replaced due to limited battery capacity to ensure the continuous use of the device.

### SUMMARY OF THE PRESENT INVENTION

To overcome shortcomings of existing techniques, the present invention provides a self-powered wearable luminous device, which is capable of providing a long-term stable energy source by collecting the energy generated by human motions, so as to achieve self-powering the wearable luminous device.

A self-powered wearable luminous device is a night running lamp which comprises a silica gel cover, a first face case, a light transmission lens, a PCBA (Printed Circuit Board Assembly) board, a wire, a power generation module, a first bottom case, a first magnet, a screw and at least one luminous component;

wherein the luminous component is mounted on the PCBA board, the first magnet is located within a groove at a bottom of the first bottom case, the power generation module is located within the first bottom case, the PCBA board is weldedly connected with the power generation module by the wire, the PCBA board is attached to a surface of the power generation module and fastened by the first bottom case, the light transmission lens is located within a groove of the first face case, all of the PCBA board, the wire, the power generation module, the first bottom base, the first magnet, the first face case and the light transmission lens are fixed by the screw for forming a main body, the silica gel cover is sleeved to the main body for forming the self-powered wearable luminous device.

The above-mentioned self-powered wearable luminous device collects the energy generated by human motions for allowing the luminous components to emit lights.

Advantages of the present invention are as follows.

(1) The self-powered wearable luminous device, provided by the present invention, is capable of generating relatively stable and high brightness lights, so that the self-power is achieved, thus the replacement of batteries is avoided.

(2) The energy collection device, provided by the present invention has simple structure and low manufacturing cost.

These and other objectives, features, and advantages of the present invention will become apparent from the following detailed description, the accompanying drawings, and the appended claims.

### BRIEF DESCRIPTION OF THE DRAWINGS

FIG. 1 is an overall structurally schematic diagram of the present invention.

FIG. 2 is a structurally schematic diagram of a power generation module of the present invention.

FIG. 3 is an internally structurally schematic diagram of the power generation module of the present invention.

FIG. 4 shows a schematic view of the first bottom case.

FIG. 5 shows a schematic view of the second bottom case.

### DETAILED DESCRIPTION OF THE PREFERRED EMBODIMENT

The present invention is further described in detail accompanying with drawings and embodiments as follows.

### Embodiment 1

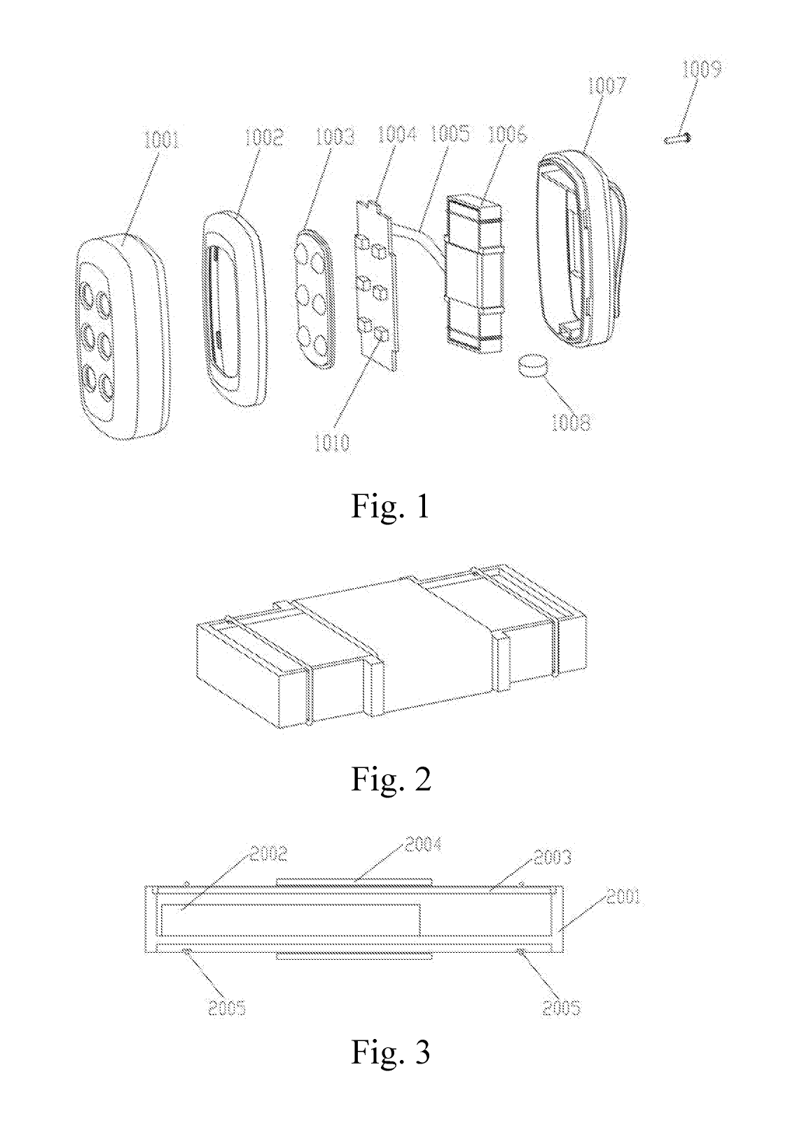

Referring to FIG. 1 of the drawings, a self-powered wearable luminous device, as a self-powered night running lamp luminous device, comprises a silica gel cover 1001, a first face case 1002, a light transmission lens 1003, a PCBA (Printed Circuit Board Assembly) board 1004, a wire 1005, a power generation module 1006, a first bottom case 1007, and a first magnet 1008, a screw 1009 with a specification of PA 1.5X6 and luminous components 1010. The whole luminous device is hung on a belt or worn on other parts of a body. While moving, the power generation module 1006 automatically generates electricity by human motions, so as to drive the luminous components via electronic components to regularly supply electricity.

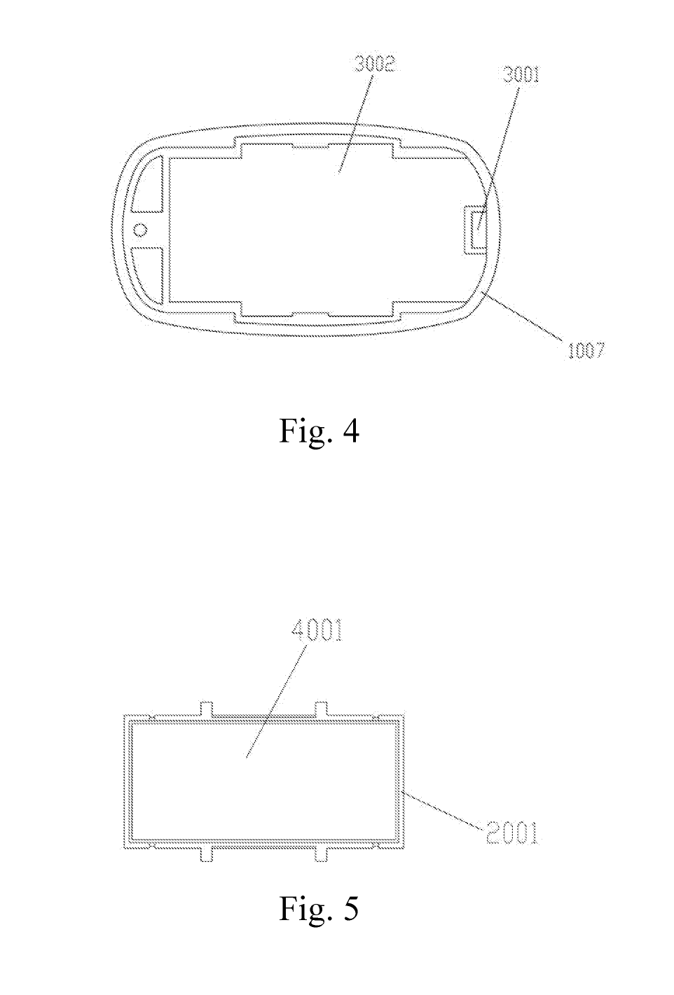

An assembly process of the complete machine is as follows. Firstly, the first magnet 1008 is put into a groove 3001 at a bottom of the first bottom case 1007 (as shown in FIG. 4). Secondly, the power generation module 1006 is put into a groove 3002 of the first bottom case 1007. Thirdly, the PCBA board 1004 (wherein the luminous components 1010 are mounted on the PCBA board 1004) is weldedly connected with the power generation module 1006 by the wire 1005. Fourthly, the PCBA board 1004 is attached to a surface of the power generation module 1006 and fastened by a buckle of the first bottom case 1007. Accordingly, the PCBA board 1004, the wire 1005, the power generation module 1006, the first bottom case 1007, and the buffer magnet 1008 form a first unit A. Fifthly, the light transmission lens 1003 is put into a fixed groove of the first face case 1002, so that the first face case 1002 and the light transmission lens 1003 form a second unit B. Sixthly, the first unit A is fixed with the second unit B by the screw 1009 with the specification of PA 1.5X6 to form a main body C. Seventhly, the silica gel cover 1001 is sleeved to the main body C for forming the self-powered night running lamp luminous device.

### Embodiment 2

Referring to FIG. 3 of the drawings, the power generation module 1006 of the self-powered night running lamp luminous device comprises a second bottom base 2001, a second magnet 2002 for providing magnetic fields, a second face case 2003, an inductance coil 2004 and O-shaped rings 2005. The self-powered night running lamp luminous device is worn on the human body. While moving, the second magnet 2002 for providing magnetic fields makes a reciprocating motion within the second bottom base 2001 relative to the inductance coil 2004, in such a manner that magnetic induction lines around the magnetic fields are cut, so that the induced currents are generated. The induced currents provide electricity for the PCBA board 1004 via the wire 1005 for enlightening the luminous components. In the present invention, the luminous components are light emitting diodes (LEDs).

An assembly process of the power generation module 1006 is as follows. Firstly, the second magnet 2002 is put into a groove 4001 of the second bottom base 2001. Secondly, the second face case 2003 is covered to the second bottom base 2001 for forming a third unit D. Thirdly, the third unit D is tied by two O-shaped rings 2005 for forming a fourth unit E. Fourthly, the inductance coil 2004 is wound within a reserved space of the fourth unit E to finally obtain the power generation module 1006.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A self-powered wearable luminous device, comprising a silica gel cover, a first face case, a light transmission lens, a PCBA board, a wire, a power generation module, a first bottom case, a first magnet, a screw and at least one luminous component;
wherein the luminous component is mounted on the PCBA board, the first magnet is located within a groove at a bottom of the first bottom case, the power generation module is located within the first bottom case, the PCBA board is weldedly connected with the power generation module by the wire, the PCBA board is attached to a surface of the power generation module and fastened by the first bottom case, the light transmission lens is located within a groove of the first face case, all of the PCBA board, the wire, the power generation module, the first bottom base, the first magnet, the first face case and the light transmission lens are fixed by the screw for forming a main body, the silica gel cover is sleeved to the main body for forming the self-powered wearable luminous device.

2. The self-powered wearable luminous device, as recited in claim 1, the power generation module comprises a second bottom base, a second magnet for providing magnetic fields, a second face base, an inductance coil and O-shaped rings, wherein the second magnet is located within a groove of the second bottom base, the second face case is covered to the second bottom base for forming a space and tying with each other through the O-shaped rings, and the inductance coil is wound within the space.

3. The self-powered wearable luminous device, as recited in claim 1, wherein the self-powered wearable luminous device is a self-powered night running lamp luminous device.

4. The self-powered wearable luminous device, as recited in claim 2, wherein the self-powered wearable luminous device is a self-powered night running lamp luminous device.

5. The self-powered wearable luminous device, as recited in claim 1, wherein the luminous component is an LED (light emitting diode).

6. The self-powered wearable luminous device, as recited in claim 2, wherein the luminous component is an LED (light emitting diode).

7. The self-powered wearable luminous device, as recited in claim 3, wherein the luminous component is an LED (light emitting diode).

8. The self-powered wearable luminous device, as recited in claim 4, wherein the luminous component is an LED (light emitting diode).
